(19) United States
(12) Patent Application Publication
(10) Pub. No.: US 2019/0050487 A1
(43) Pub. Date: Feb. 14, 2019

(54) Search Method, Search Server and Search System

(71) Applicant: Alibaba Group Holding Limited, Grand Cayman (KY)

(72) Inventor: Guoxin Wang, Hangzhou (CN)

(21) Appl. No.: 16/054,754

(22) Filed: Aug. 3, 2018

(30) Foreign Application Priority Data
Aug. 9, 2017 (CN) 201710675576.1

(51) Int. Cl. G06F 17/30; G06Q 30/02; G06Q 30/06

(52) U.S. Cl. CPC G06F 17/30867; G06F 17/30696; G06Q 30/0641; G06F 17/30705; G06Q 30/0201

(57) ABSTRACT

A search method, a search server and a search system are provided in the present disclosure. The method includes acquiring feature data of a user and a search keyword; generating text files associated with product clusters according to the feature data of the user and the search keyword; and displaying the text files associated with the product clusters on a search result browsing interface corresponding to the search keyword. Using the technical solutions provided by the embodiments of the present disclosure, a user can be made to stay in a search interface in a more effective way, thus effectively increasing a click-through rate and a transaction rate of the user.

### CROSS REFERENCE TO RELATED PATIENT APPLICATIONS

This application claims priority to Chinese Patent Application No. 201710675576.1, filed on 9 Aug. 2017, entitled “Search Method, Search Server and Search System,” which are hereby incorporated by reference in its entirety.

### TECHNICAL FIELD

The present disclosure relates to the technical field of the Internet, and particularly to search methods, search servers, and search systems.

### BACKGROUND

With the development of Internet technology, more and more people are completing the purchase of products through the Internet, which has also led to the development of electronic production services. In the environment of electronic production services, a search has always been the most important way for consumers to find a product.

During the process of searching and product browsing, an electronic product platform often hopes to provide a user with products that more closely match the user's search intent, so as to achieve the goal of increasing the platform's transaction rate.

In an existing production platform, after a user inputs a search keyword, usually only products based on the search keyword are present. At most, keywords similar to the instant search keyword appear, and the user is thereby prompted to click on a similar keyword to trigger a new search, thereby increasing the time that the user spends on browsing. In other words, by recommending a new search keyword to the user, the duration of the user staying in a search interface is increased to satisfy the user's final shopping needs as much as possible.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The purpose of the present disclosure is to provide a search method, a search server and a search system, which can realize display of product clusters based on a text file file, so as to improve a click-through rate and a conversion rate after a search.

A search method, a search server, and a search system provided by the present disclosure are implemented as follows.

A search method includes obtaining feature data of a user and a search keyword; generating a text file associated with a product cluster based on the feature data of the user and the search keyword; and displaying the text file associated with the product cluster on a search result browsing interface corresponding to the search keyword.

A search server includes An acquisition module used for obtaining feature data of a user and a search keyword; a generation module used for generating a text file associated with a product cluster based on the feature data of the user and the search keyword; and a display module used for displaying the text file associated with the product cluster on a search result browsing interface corresponding to the search keyword.

A search system includes the search server as mentioned above and a plurality of user clients, wherein the user client is configured to obtain search keywords inputted by a user, present a text file displayed by the search server, and display a product cluster associated with the text file in response to receiving a click command of the text file.

A search method includes obtaining feature data of a user and a search keyword; generating a text file associated with a product cluster based on the feature data of the user and the search keyword; and displaying the text file associated with the product cluster on a user purchase activity result interface corresponding to the search keyword.

A computer-readable storage medium having stored a computer program thereon that, when executed by processor(s), implements the operations of the above method.

The search method, the search server, and the search system provided by the present disclosure generate a text file associated with a product cluster through feature data of a user and a search keyword, and push the text file associated with the product cluster to the user. Since pushing to a user is performed in a manner of text file, this can facilitate the user to stay in a search interface in a more effective way, thus effectively increasing a click-through rate and a transaction rate of the user.

### BRIEF DESCRIPTION OF THE DRAWINGS

In order to describe embodiments of the present disclosure or the technical solutions in existing technologies more clearly, drawings that are needed for describing the embodiments are briefly described hereinafter. Apparently, the drawings described hereinafter merely represent some embodiments described in the present disclosure. For one skilled in the art, other drawings may also be obtained based on these drawings without any creative labor.

FIG. 1 is a schematic structural diagram of a search system provided by the present disclosure.

FIG. 2 is a schematic diagram of a search interface provided by the present disclosure.

FIG. 3 is another schematic diagram of a search interface provided by the present disclosure.

FIG. 4 is still another schematic diagram of a search interface provided by the present disclosure.

FIG. 5 is a schematic structural diagram of a two-stage sorting generated text file provided by the present disclosure.

FIG. 6 is a schematic diagram of a product cluster two-stage screening provided by the present disclosure.

FIG. 7 is a method flowchart of a search method provided by the present disclosure.

FIG. 8 is a structural diagram of a search server provided by the present disclosure.

### DETAILED DESCRIPTION

In order to enable one skilled in the art to better understand the technical solutions in the present disclosure, the technical solutions in the embodiments of the present disclosure are described clearly and completely herein with reference to the accompanying drawings in the embodiments of the present disclosure. Apparently, the described embodiments merely represent a part and not all of the embodiments of the present disclosure. Based on the embodiments of the present disclosure, all other embodiments obtained by one of ordinary skill in the art without making any creative effort shall fall within the scope of protection of the present disclosure.

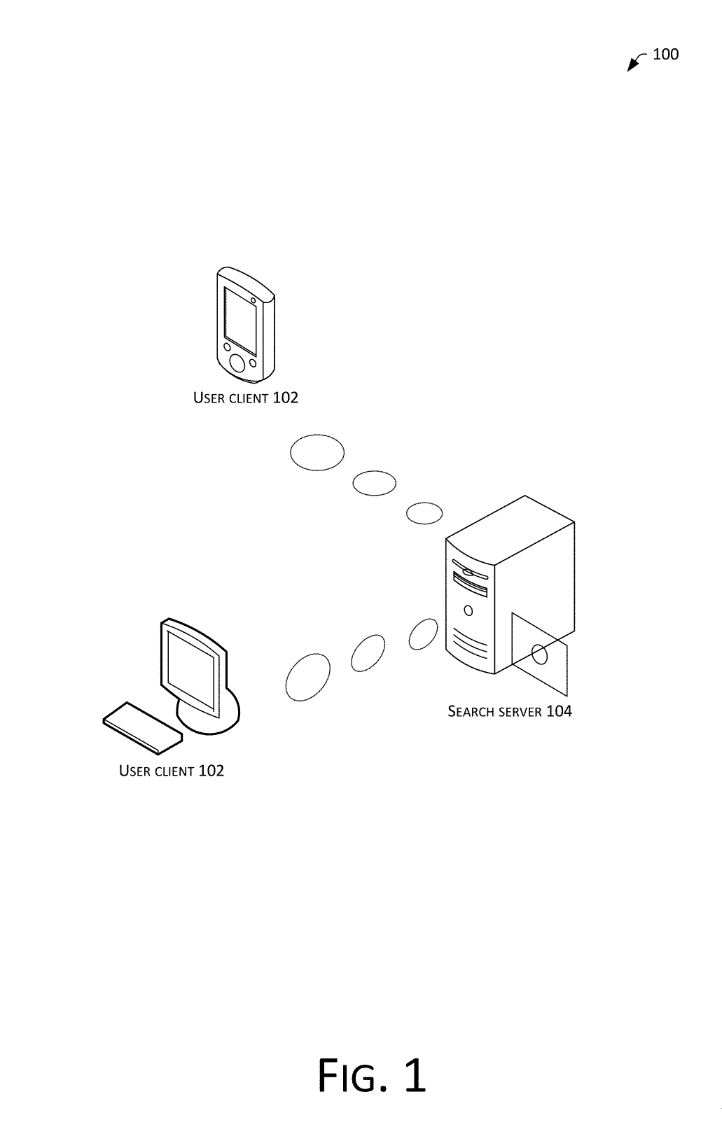

Referring to FIG. 1, the present disclosure provides a search system 100. The search system 100 may include a user client 102 and a search server 104. The user client 102 is coupled to the search server 104. The search system may have one or more user clients 102.

In implementations, the user client 102 may be a mobile device such as, for example, may be a mobile phone, a tablet computer, or the like. The user client 102 may also be a desktop device, such as an all-in-one machine, or the like.

A user can use different user clients 102 to log into the search server 104 to perform search operations in different scenarios. In order for the search server 104 to enable a user to continue searching and browsing in a search result interface when the user performs a target object search, a text file associated with a product cluster can be pushed to the user when the user browses search results. Therefore, a browsing time of the user can be effectively extended when the user logs into an electronic production platform through a user client 102 to perform product searches, thus improving a click-through rate and a turnover rate of the platform.

In implementations, the search server 104 may obtain feature data of a user and a search keyword, generate a text file associated with a product cluster based on the feature data of the user and the search keyword, and pushes the text file associated with the product cluster to a search result browsing interface corresponding to the search keyword.

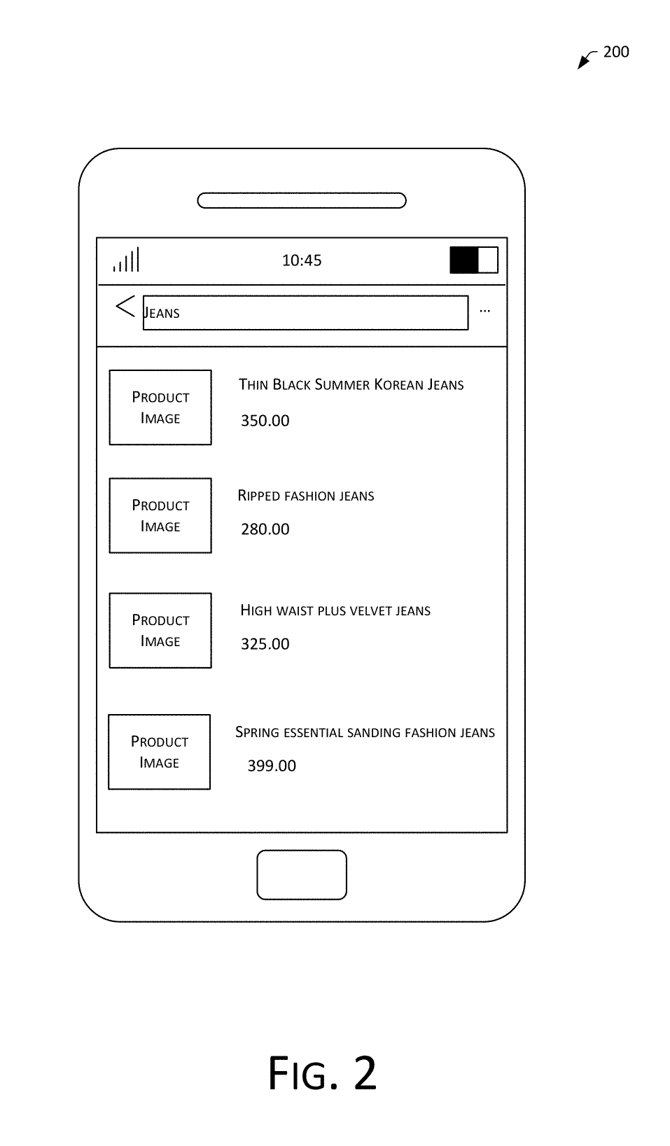

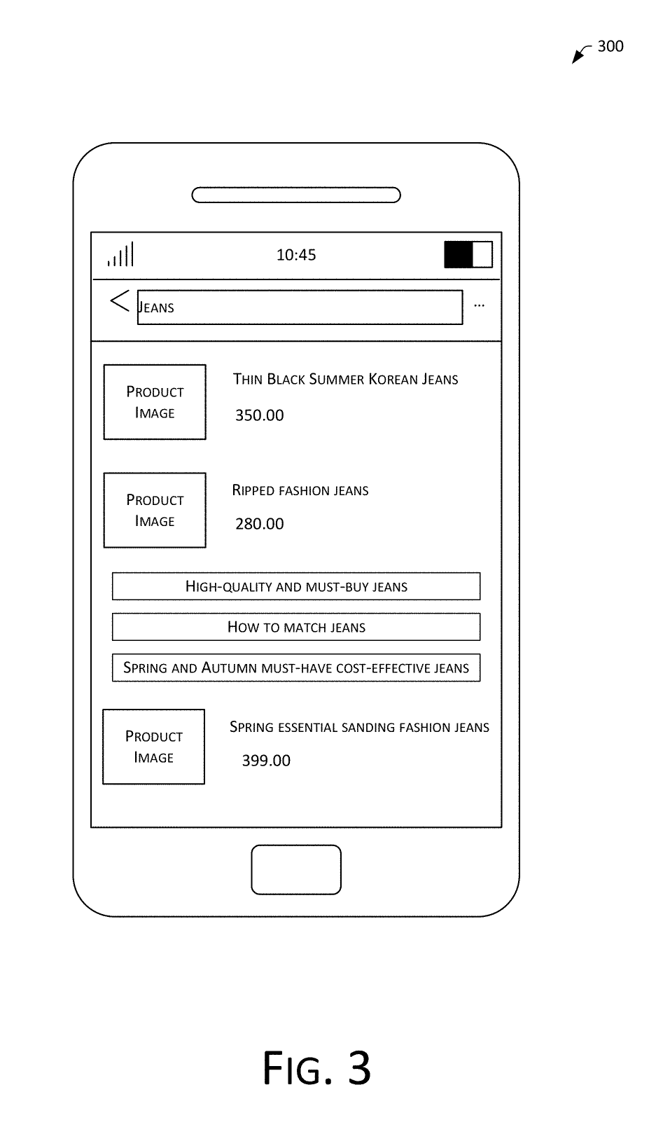

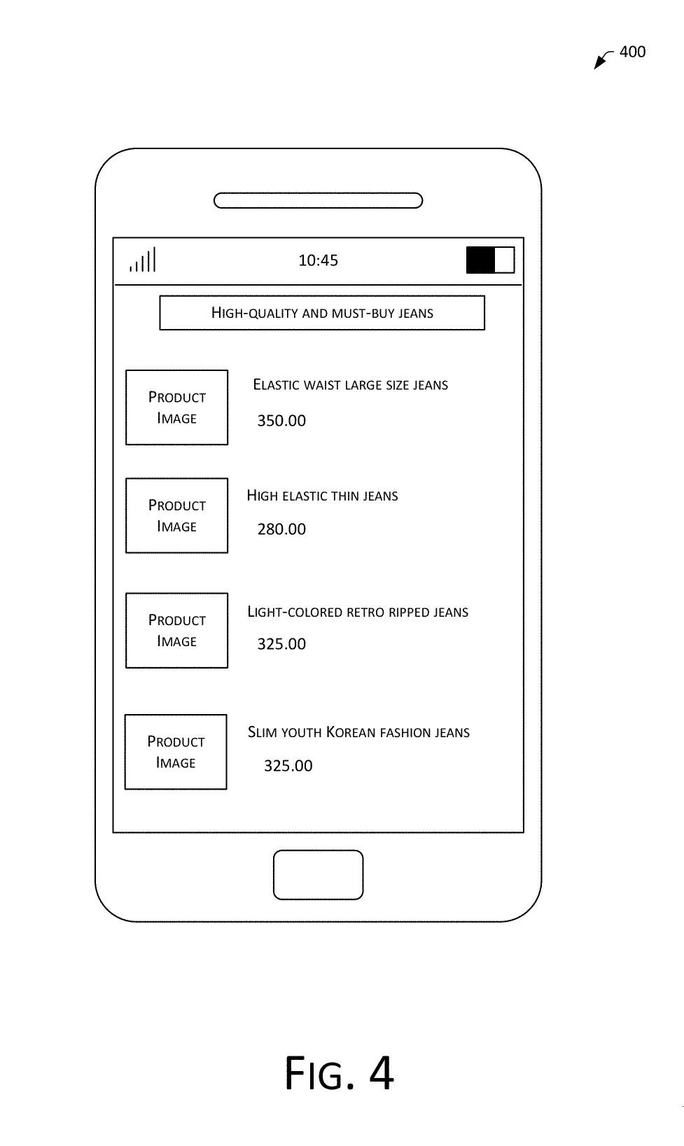

For example, Zhang San logs onto an electronic production platform to search for “jeans” through the user client 102. At this time, a search keyword that is obtained is “jeans”, and a search result page as shown in FIG. 2 is formed in a conventional manner. In this example, feature data of Zhang San, for example, “age: 28 years old”, “gender: male”, and the like, may be obtained at the same time. As shown in FIG. 3, several text files generated for Zhang San can be pushed, for example, “high-quality and must-have jeans”, etc. to Zhang San. If Zhang Sank clicks and opens a text file, a product page as shown in FIG. 4 can be seen, a collection of jeans products associated with the text file can be browsed. As such, the interests of Zhang San to continue browsing are further enhanced, thus helping to increase a click-through rate and a transaction rate.

In implementations, after the search server 104 generates a text file associated with a product cluster, the text file may not only be displayed on a search interface page, but also be displayed on other pages. For example, the text file may be displayed on an operating page for adding to a shopping cart, an operation page for deleting a product, an operation page for creating an order, an operation page for deleting an order, etc. Alternatively, the text file can also be displayed on a page after a user completes an order, or a page on which a user conducts an evaluation for an order. The text file may even be displayed on a main page switched during a browsing process or a purchasing process of a user. A message pushing method or the like may also be used to directly push the text file associated with the product cluster to the user in a form of a software alert message or a software push message, etc. The aforementioned ways of presenting a generated text file associated with a product cluster are merely exemplary illustrations. In a real implementation, other possible manners of presentation can be conceived, and the present disclosure does not have any limitations thereon.

In an implementation, the search server 104 may determine a basic feature vector of a user under a search keyword according to feature data of the user, and then acquire a product cluster set. The product cluster stores a number of product clusters, and each product cluster corresponds to a product cluster feature vector. According to the basic feature vector of the user, a respective product cluster feature vector of each product cluster, and historical click activity data of the user, a preset number of product clusters are selected from the product cluster set, and matching is performed for the preset number of product clusters to generate text files.

Specifically, multiple collections of product clusters have been collected in the search server 104 in advance. Using jeans as an example, a plurality of jeans-based product clusters have been aggregated in the search server 104. After a basic feature vector of a user is obtained, some product clusters can be selected from these product clusters and pushed in a form of text files based on the user's basic feature vector and the user's historical click activity. The user's historical click activity may include, but is not limited to, click purchase activity of the user in recent days due to a jeans-based search, the user's jeans-based collection activity, the user's historical purchase record based on jeans, and the like. At the same time, the user's browsing and clicking records during a current search are also needed because these are real-time user activity data. If all the product clusters are sorted using these real-time activities, the calculation efficiency will be lower. Therefore, the search server 104 may first perform a screening using basic features of the user, and select product clusters suitable for the user (e.g., Zhang San) to make a candidate product cluster set (for example, select 100 clusters). Then, through the user's real-time historical activity data, a number of most matching product clusters are selected from these 100 clusters as product clusters that are finally pushed. For example, three of the 100 clusters can be selected as finally pushed product clusters.

Specifically, the search server 104 may select a plurality of product clusters whose degree of similarity between a product cluster feature vector and a basic feature vector of a user exceeds a preset threshold from a product cluster set to form a candidate product cluster set, obtain the user's historical click activity data, and select a preset number of product clusters with the highest matching degree from the candidate product cluster set according to the historical click activity data of the user.

After selecting product clusters to be pushed, text files can be matched for the product clusters. For example, if three product clusters having the highest matching degree are finally selected, and text files can be generated for these three product clusters. When a text file is generated, one of the following methods, through not being limited thereto, can be performed:

Method 1) Separately select a text file for each product cluster in a preset number of product clusters from a pre-established text file set, i.e., a set of text files is created in advance and selection can be made directly therefrom.

Method 2) Obtain click rate data of a user with respect to past text files, and separately generate a text file for each product cluster in a preset number of product clusters according to the click rate data and a search keyword in combination with features of products in the product clusters, i.e., a text file is generated directly according to the user's choice and preference.

However, in order to allow a generation of a text file that meets individual needs of a user in a short time, a collection of text files can be generated offline. A user-text click-through rate prediction model is then generated based on the user's historical click conditions of text files. Based on the prediction model, a text file with a high click-through rate for the user is served as a finally determined text file, and is pushed as a text file of a product cluster.

For example, for a search keyword “jeans”, two types of text files are generated: a strong conversion type text file (for example, high-quality and must-buy jeans) and a content type text file (for example, “how to match jeans”). Furthermore, a determination is made that the probability that the user Zhang San clicks on the content type text file is higher, i.e., the likelihood of clicking: “How to match the jeans” is higher. Therefore, the text file “How to match the jeans” is pushed as a text file of a product cluster in a plurality of selected product clusters. After the user clicks on the text file, information of products in the product cluster associated with the text file can be presented.

In a process of collecting a collection of historical text files, the search server 104 may first obtain text file information of the historical text files, for example, obtaining information in the text files such as categories, products, brands, release times, conversion rates, transaction conversion rates, keywords, etc., and text files are then selected to generate the collection of text files based on the text file information of the historical text files.

In implementations, in order for the search server 104 to separately select a text file for each product cluster in a preset number of product clusters from a pre-established copy set and for the selected text files to have higher hit rates, the search server 104 may obtain click rate data of a user with respect to historical text files, then sorts each text file in a collection of text files in an order of respective click rates based on the click rate data of the user with respect to the historical text files, and finally select text files matching product clusters of which text files are to be generated and having a high click rate as text files of the product clusters of which text files are to be generated.

The above manner of generating a text file is merely a schematic description. In a real implementation, other methods may also be selected to generate and select a text file, which is not limited in the present disclosure.

In implementations, the search server 104 may push generated text file(s) associated with product cluster(s) at a jump-off point of a current search that is predicted, so that a user may continue to stay in a search interface. A jump-off point refers to leaving a search page when a user cannot complete a transaction in a current page, and a position at which a user leaving a search page is generally referred to as a jump-off point in the industry.

When predicting a jump-off point of a current search of a user, a determination may be made based on the user's historical search browsing record. For example, statistics can be conducted on the historical browsing record to determine after browsing which number of pages the user will generally leave, and that page can then be taken as a jump-off point. For example, the user often leaves after viewing the third page of search results pages, and the third page of the browsing result can then be used as a jump-off point. Apparently, other methods can also be used for determination, for example, a frequency of a user clicking products on a search result interface, etc., and can be used as a way to predict a jump-off point.

It should be noted, however, that the above-mentioned manner of predicting a jump-off point is merely an illustrative description, which is not limited in the present disclosure.

In implementations, the search server 104 may display or push the text file(s) in other places, in addition to displaying the text file(s) near the predicted jump-off point, for example, in a manner of pushing at any time during the user's browsing, or on a periodic basis, etc. Details of a time point of pushing are not specifically limited in the present disclosure.

In implementations, the user client 102 may acquire a search keyword inputted by a user, and may also present text file(s) pushed by the search server. The user client 102 may display a product cluster associated with a text file after receiving the user's click command on the text file.

An execution process of the above search system is described hereinafter in conjunction with a specific scenario and a system processing flow. However, it should be noted that this specific embodiment is merely used for a better description of the present disclosure and does not constitute an improper limitation of the present disclosure.

In this example, considering that actual search intentions of users are difficult to be reflected directly through search keywords, the use of text files and product clusters can be considered to more appropriately represent the needs of consumers, thereby making interactions with the consumers. That is, after a user inputs a search term, recommended text file(s) is/are given to when the user browses a search result. After the user clicks on a text file, a collection page of a product cluster associated with the text file may be entered. Accordingly, a scheme for pushing a product cluster based on a text file is proposed. Specifically, according to real-time browsing and clicking activities of a user, a determination is automatically made as to whether a product cluster can be recommended and the product cluster is presented to the user in a form of a text file. Pushing a product cluster in a form of a text file can effectively improve the degree of satisfaction of a user with respect to a search, and thus achieve the purpose of increasing a click volume and a transaction volume.

From an overall process, the following operations can be included:

S1: Excavate a batch of products to form a recommended product cluster through a keyword inputted by a user, basic information of the user, and behavior data of the user.

S2: Calculate a similarity relationship between product clusters and text files using historical text file data that is collected, and then combine product clusters with text files.

S3: Create a click model, and recommend created text file(s) associated with product cluster(s) directly to the user in a form of the click model.

For example, when a user searches for “toothbrush”, related keywords such as “nano-toothbrush”, “toothbrush set”, etc., will be recommended to the user to guide the user to continue clicking if a form of directly pushing similar keywords is used. A new search is initiated after clicking.

In this example, when the user searches for “toothbrush”, text files such as “purchase of baby teeth toothbrush” and “quickly pick up mass retail version of toothbrush” are recommended to the user, for example. After the user clicks on a text file, a product cluster associated with the text file is entered.

As can be seen, a way of recommending similar search keywords is essentially a type of search navigation. Clicking of a user is manifested as a further refinement of a current search keyword. A technical solution thereof is to create a model for clicking of keywords, to use the keywords as a starting point. Since results of clicked products are not introduced in the model, a greater need of the user for recommendation of suitable products fails to be resolved directly.

In this example, based on real-time recommendation technologies, a model is created for a search intent of the user from the perspective of recommending suitable products to satisfy the needs of the user, recommended product clusters are matched directly from the perspective of products that the user may be interested in. As such, results that are pushed are more in line with the needs of users. By breaking the deficiencies of descriptions and insufficient appealing of keywords, associations between text files and product clusters are established. Texts matching natural voices are directly pushed to consumers. Furthermore, in an algorithm of evaluating a text file, a behavioral relationship between a user and historical text files is introduced to achieve the purpose of personalized recommendation of a text file.

During implementation, the search server 104 may specifically include the following modules: a user real-time behavior feature computation module, a product cluster selection and sorting module, a text file generation module, etc. Specifically, these modules can perform the following operations:

1) User real-time behavior feature computation module:

Collect data such as a user's current search keyword, the user's click activities in the most recent period of time, additional purchase activities and purchase activities, etc., and processes the data on a real-time computing platform into feature vectors capable of describing the user's current preferences.

The feature vectors can be divided into basic features and sorting features, where the basic features are used for obtaining candidate product clusters, and the sorting features are used for sorting strategies. Therefore, the basic features (user's gender, age, etc.) select features that are relatively fixed and do not depend on real-time calculations, and can be stored in different systems through offline processes when implemented. The sorting features (products, brands, stores, etc. that the user clicks) need to rely heavily on real-time computing capabilities to meet the requirements of optimal sorting through rapid changes.

2) Product cluster selection and sorting module:

The basic features can be used to match related and high statically scored product clusters (assuming that there are 50). These product clusters can be generated in real-time based on a product-product similarity algorithm centered on popular products and business rules.

The above 50 product clusters are sorted, and the first 3 are selected as finally selected product clusters. Specifically, a sorting service may be used to perform computations on user feature vectors and product cluster feature vectors to obtain sortings of the product clusters.

3) Text file generation module:

For product clusters that have been sorted, texts can be selected from a text file library or a text library based on a relationship between product vectors and text vectors, to form associated text files, and to establish a relationship between the text files and the product clusters.

After the user sees the text files, whether the user makes a click and whether the user makes a purchase after the click may be fed back to a product cluster generation module and a sorting strategy module to perform optimization.

In implementations, when feature data of a target object is represented, the following types of feature data may be used to form a feature vector. For example, if a user is used as a target object as an example, a gender of the user, an age, a cell phone type, whether the user likes or ignores a product in a product cluster in the past, a difference between the user's last click on a product and a current time, a loss rate and conversion rate of the user under a text can be used as feature data for forming a feature vector.

In order to enable the feature data to further reflect preferences of the user, an association relationship between the user and the text, an association relationship between the user and a seller, an association relationship between the user and a product, or a relationship between the product and the text, etc., may be established. Examples include what type(s) of text the user prefers, what seller(s) the user prefers, what type(s) of product the user prefers, what type of text description a particular type of product uses, and so on. In other words, the user, the seller, the product, and the text are associated so that the feature data can more fully reflect features.

It should be noted, however, that the content included in the above listed feature data is merely a schematic description, and other types of content may also be used as feature data, as long as features of a target object can be described, and the present disclosure does not have any limitation thereon.

During an execution, sorting features can also be calculated using real-time behavior data that is fed back. Specifically, an online log collection system may be used to obtain data about a degree of satisfaction of a user for a recommendation message (for example, whether or not the user clicks, whether or not a purchase is made after clicking) to update sorting features of the user and product clusters, thereby updating a sorting strategy and optimizing a generation logic of product clusters.

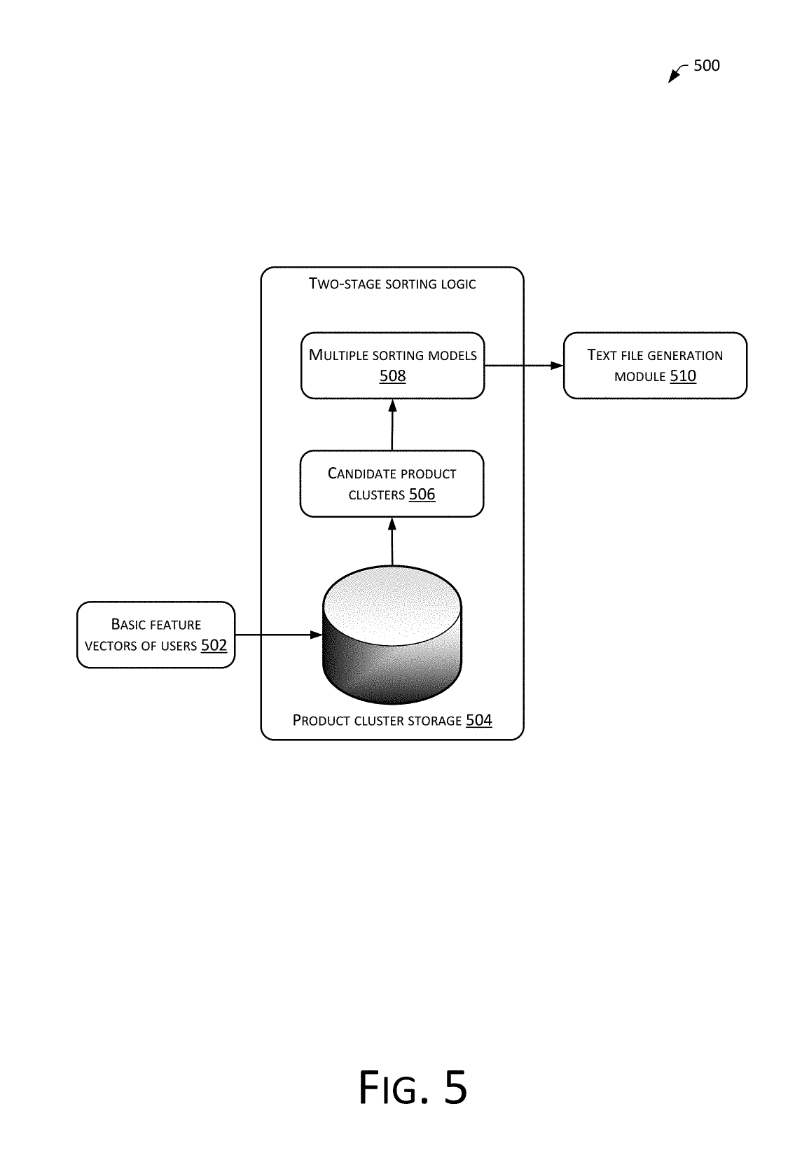

FIG. 5 shows a schematic diagram of a two-stage sorting strategy 500 in accordance with the present application. After features of a user and a product cluster is extracted, a basic feature vector of the user and a basic feature vector of the product cluster can be obtained, which can be stored in different service systems. When the user initiates an access, an online service may acquire and calculate 502 the user's basic feature vector under a current keyword, which may be referred to as a “query vector.” A query on a product cluster storage system is initiated 504 through the query vector, and a batch of product clusters having the highest degree of vector similarity is obtained 506 to form a candidate set. In other words, by calculating and comparing similarities between the query vector and base feature vectors of product clusters, the product clusters can be quickly screened, filtering out most of the unrelated product clusters and thus reducing the consumption of computations for detailed sorting 508 at a subsequent stage. When comparing similarities, a method of calculating a distance between vectors to determine a degree of similarity can be used.

After a candidate set is acquired, since the number of product clusters in the candidate set is not very large, more complicated calculations can be supported. Specifically, product clusters in the candidate set can be sorted to optimize user clicking activities. Therefore, historical user activities can be used as a samples and supervised learning can be performed using sorting features to optimize a click rate. When a collection of candidate product clusters is obtained, different similarity calculation methods may be used to achieve the purpose of quickly reducing a scope of retrieval.

Top N product clusters are assumed to be selected from the candidate set. The top N product clusters are subjected to an operation of text file generation 510, i.e., generating text files for the product clusters that are at the front end of a sorting result.

In implementations, a text file may be selected from a historical text file repository as a text file of a selected product cluster. The historical text file repository can be a large number of artificially generated text files. When a text file matching a product cluster is matched from the historical text file repository, this may be performed based on activity data of a user on specific text files. For example, text sorting features may be extracted from activity data of users about specific text files, and then the users' preference models for the text files may be generated based on the users' text sorting features. Based on the users' preference models for the text files, different users can be provided with different text files.

The above method is described hereinafter in conjunction with a specific scenario.

After a user A enters a search interface, a system can obtain the user's own data u, the user's input search keyword q, and the user's most recent activity data d.

For example, if the user A searches for “jeans” and has some clicking activities, the user's own data u, the user's input search keyword q, and the user's latest activity data d may be organized and combined to form a product cluster query vector, which may include the following content:

1) Category information corresponding to the search keyword q, for example, “jeans” corresponding to categories of jeans under wears for men and women.

2) The user's own demographic information, such as age, gender, etc.

3) Data about the user's most recent clicked products, brands, and stores.

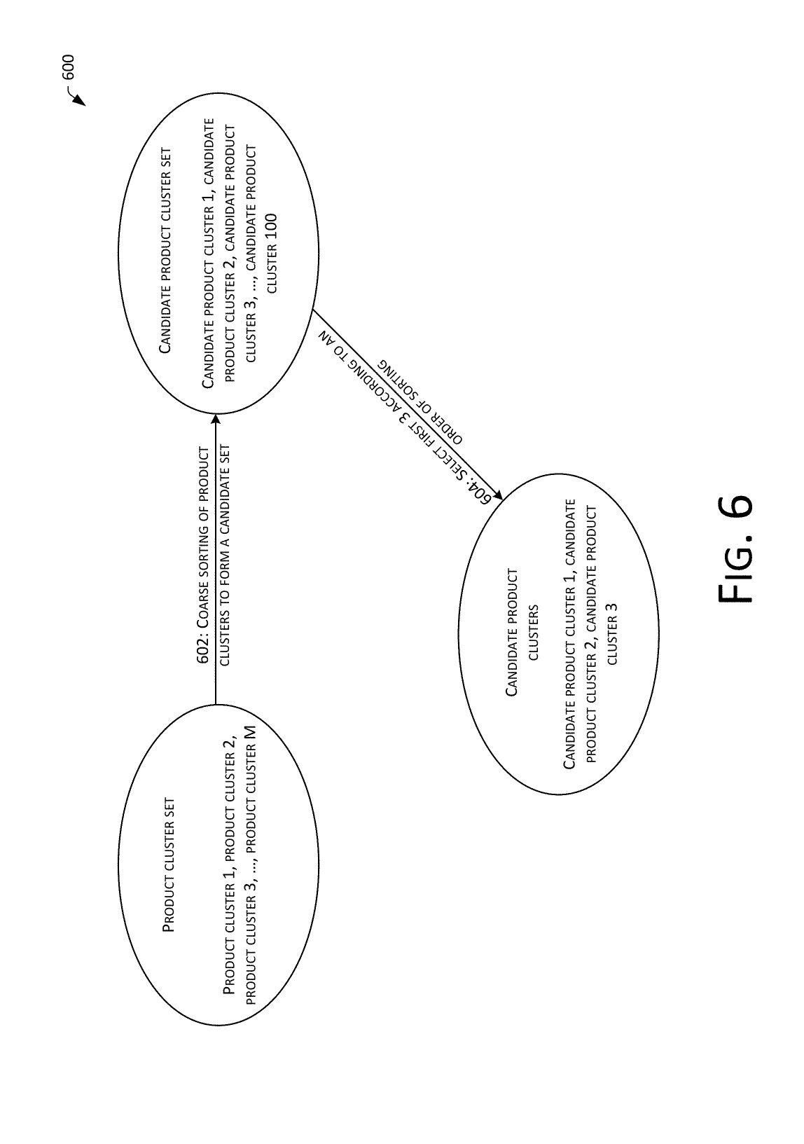

Through these pieces of information, as shown in FIG. 6, top M related product clusters can be obtained from a product cluster online query service. If 100 product clusters are obtained, this process can be referred to as a coarse sorting (602) of product clusters.

The 100 product clusters obtained by the coarse sorting can be scored, and a number of product clusters having the highest scores are selected as finally matched product clusters to be pushed. For example, three product clusters having the highest scores are selected as final product clusters to be pushed. This process can be called a fine sorting of product clusters (604).

A process of generating a text file can be divided into offline and online processes.

1) Offline Process

An offline process can be an organization and analysis of historical text files collected from electronic production platform(s).

For example, a text file: “To be stylish and warm in winter, a velvet-added jeans help you to achieve” is obtained, and off-line analysis can then include the following information extracted from the text file:

a: Category, product, brand, and release time corresponding to the text file;

b: Click-through rate and transaction conversion rate of the text file;

c: Core keyword in the text file.

2) Online Process

In an online process, the information extracted from the offline process can be used to find text files appropriate for the three product clusters after the fine sorting. It should be noted that many-to-many relationship may exist between product clusters and text files. Therefore, different users can pre-establish respective user-text click-through rate prediction models. For example, some users may prefer a strong conversion type of text file of “high-quality and must-buy jeans,” and some users prefer a content type of text file “how to match jeans” for the same jeans. Therefore, by pre-establishing user-text click-through rate prediction models performing for text file selection, a more appropriate text file can be identified, which can effectively increase a click-through rate of a user.

Through the above processing, text files associated with product clusters that satisfy a user's personality can be generated and pushed to the user. The user clicks can see a corresponding product cluster after clicking on a text file. When the text file is pushed, pushing can be performed at a jump-off point of the user that is determined and predicted, or pushing can be performed directly in a search result page during the user's browsing. A position of the pushing is not limited in the present disclosure.

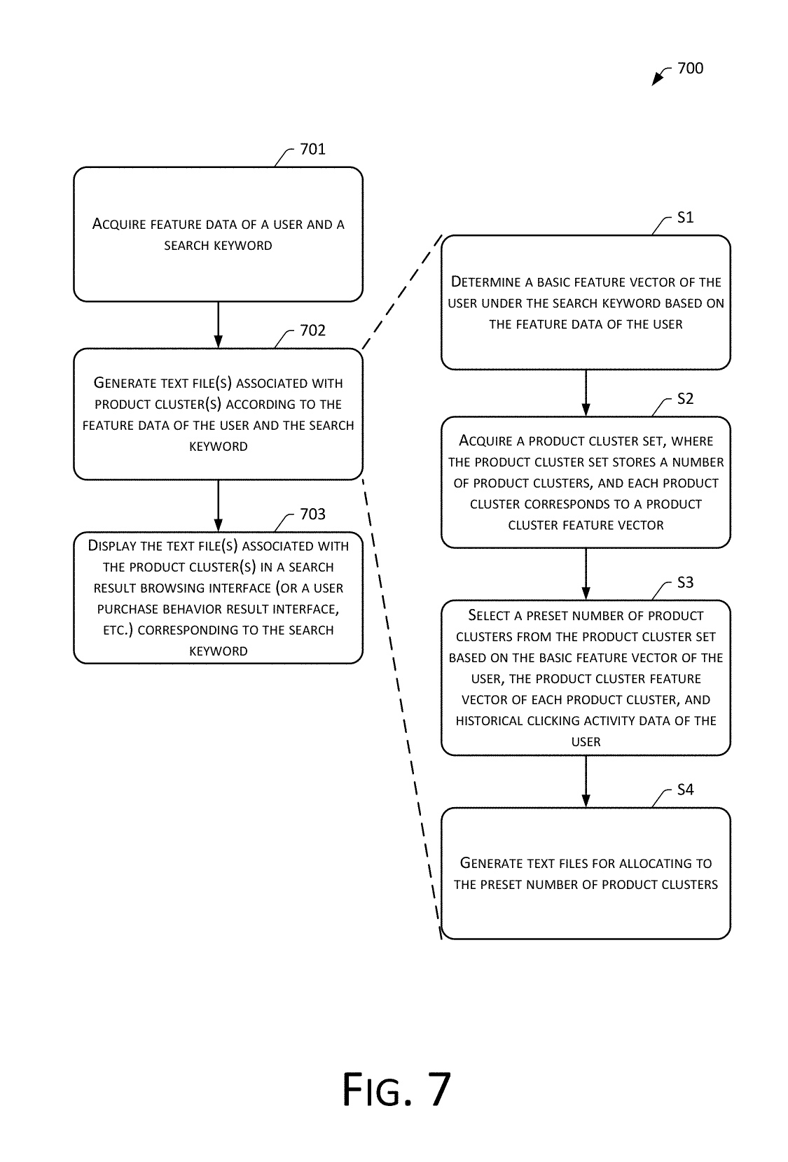

As shown in FIG. 7, in the embodiments of the present disclosure, a search method is also provided, which may include the following operations:

Operation 701: Acquire feature data of a user and a search keyword.

Operation 702: Generate text file(s) associated with product cluster(s) according to the feature data of the user and the search keyword.

In implementations, a text file associated with a product cluster may be generated according to the following operations, which include the operations.

S1: Determine a basic feature vector of the user under the search keyword based on the feature data of the user.

The basic feature vector of the user may include, but is not limited to, at least one of the following: the user's age, the user's gender, and the user's city.

S2: Acquire a product cluster set, where the product cluster set stores a number of product clusters, and each product cluster corresponds to a product cluster feature vector.

S3: Select a preset number of product clusters from the product cluster set based on the basic feature vector of the user, the product cluster feature vector of each product cluster, and historical clicking activity data of the user.

When implemented, a coarse selection can be performed first, and a fine selection is then performed. During coarse selection, some basic static data are used for selection. During fine selection, the selection is made according to the user's historical factual behavior data. Specifically, a plurality of product clusters whose degree of similarity between a respective product cluster feature vector and the user's basic feature vector exceed a preset threshold may be selected from the product cluster set to form a candidate product cluster set. Historical clicking activity data of the user may be acquired. According to the historical clicking activity data of the user, a preset number of product clusters with the highest matching degree are selected from the candidate product cluster set.

S4: Generate text files for allocating to the preset number of product clusters.

When a text file is generated, one of the following ways can be used and performed:

Method 1) Select a text file for each product cluster in the preset number of product clusters from a set of pre-established collection of text files, wherein: for the collection of text files, text file information of historical text files can be obtained, with the text file information including at least one of the following: categories, products, brands, times of release, conversion rates for placement, conversion rates for complete transaction, and keywords, and text files are selected to form the collection of text files based on the text file information of the historical text files.

Specifically, the user's click-through rate data for the historical text files may be obtained. According to the user's click-through rate data for the historical text files, each text file in the collection of text files is sorted according to respective click-through rates. Text files matching product clusters of which respective text files are to be generated product and having high click-through rates are selected as the respective text files for the product clusters of which respective text files are to be generated.

Method 2) Obtain click-through rate data of the user's historical text files; and generate a text file for each product cluster in the preset number of product clusters based on the click-through rate data, the search keyword, and features of products in the product clusters.

Operation 703: Display the text file(s) associated with the product cluster(s) in a search result browsing interface (or a user purchase behavior result interface, etc.) corresponding to the search keyword.

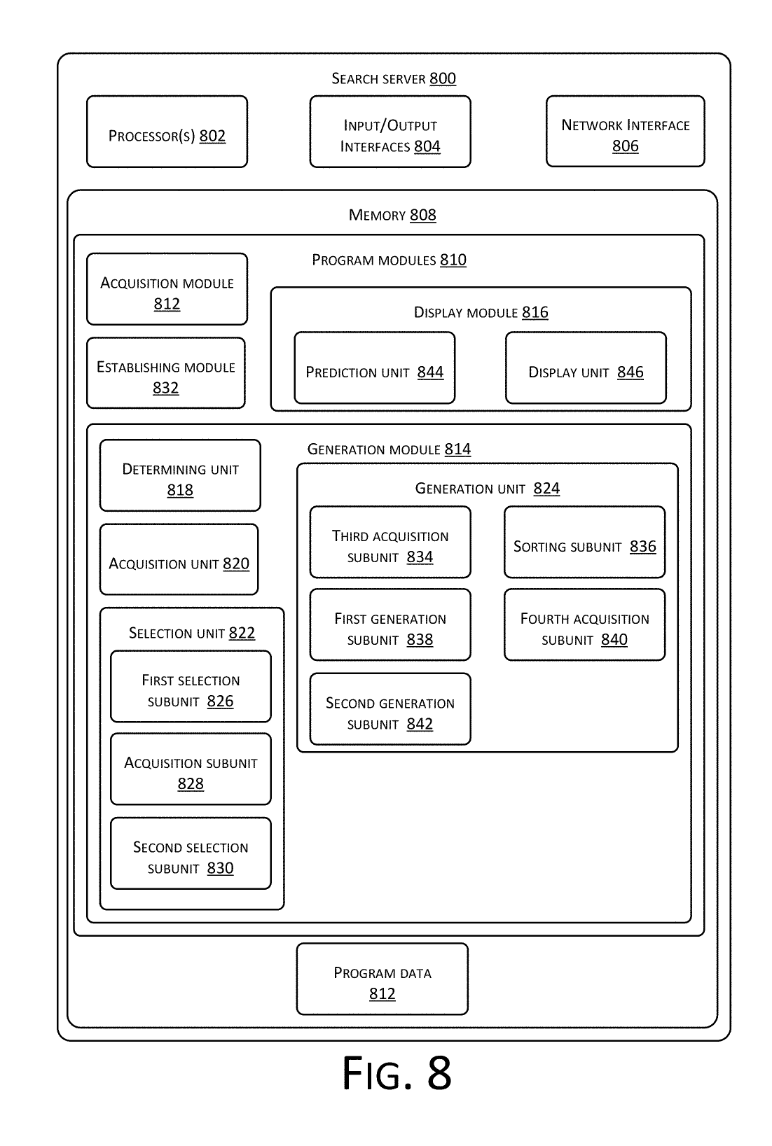

FIG. 8 shows a structural diagram of a search server 800 in accordance with the present disclosure. In implementations, the search server 800 may include one or more computing devices. In implementations, the search server 800 may be a part of one or more computing devices, e.g., implemented or run by the one or more computing devices. In implementations, the one or more computing devices may be located in a single place or distributed among a plurality of network devices over a network. By way of example and not limitation, search server 800 may include one or more processors 802, an input/output (I/O) interface 804, a network interface 806, and memory 808.

The memory 808 may include a form of computer readable media such as a volatile memory, a random access memory (RAM) and/or a non-volatile memory, for example, a read-only memory (ROM) or a flash RAM. The memory 808 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 808 may include program modules 810 and program data 812. The program modules 810 may include an acquisition module 812 to obtain feature data of a user and a search keyword; a generation module 814 to generate text files associated with product clusters based on the feature data of the user and the search keyword; and a display module 816 to display the text files associated with the product clusters on a search result browsing interface corresponding to the search keyword.

In implementations, the generation module 814 may include a determining unit 818 configured to determine a basic feature vector of the user under the search keyword based on the feature data of the user; an acquisition unit 820 configured to obtain a product cluster set, where the product cluster set stores a plurality of product clusters, and each product cluster corresponds to a product cluster feature vector; a selection unit 822 configured to select a preset number of product clusters from the product cluster set based on the basic feature vector of the user, the product cluster feature vector of each product cluster, and historical clicking activity data of the user; and a generation unit 824 configured to generate text files for the preset number of product clusters.

In implementations, the selection unit 822 may include a first selection subunit 826 configured to form a candidate product cluster set consisting of a plurality of product clusters whose degree of similarity between a respective product cluster feature vector and the basic feature vector of the user exceeds a preset threshold from the product cluster set; an acquisition subunit 828 configured to obtain historical clicking activity data of the user; and a second selection subunit 830 configured to select a preset number of product clusters with a highest matching degree from the candidate product cluster set based on historical clicking activity data of the user.

In implementations, the generation unit 824 is further configured to select a text file for each product cluster in the preset number of product clusters from a pre-established collection of text files.

In implementations, the search server 800 may further include an establishing module 832 configured to establish the pre-established collection of text files by obtaining text file information of historical text files, wherein the text file information includes at least one of the following: categories, products, brands, times of release, conversion rates for placement, transaction conversion rates, and keywords, and selecting text files to generate the collection of text files based on the text file information of the historical text files.

In implementations, the generation unit 824 may include a third acquisition subunit 834 configured to obtain click-through rate data of the user for the historical text files; a sorting subunit 836 configured to sort each text file in the collection of text files according to respective click-through rates based on click-through rate data of the user for the historical text files; and a first generation subunit 838 configured to select text files matching product clusters of which respective text files are to be generated and having a high click-through rate as the respective text files of the product clusters of which the respective text files are to be generated.

In implementations, the generation unit may further include a fourth acquisition subunit 840 configured to obtain click-through rate data of the user for historical text files; and a second generation subunit 842 configured to generate a text file for each product cluster in the preset number of product clusters based on the click-through rate data, the search keyword, and features of products in the product clusters.

In implementations, the display module 816 may include a prediction unit 844 configured to predict whether a predicted jump-off point of the search result browsing interface corresponding to the search keyword is reached; and a display unit 846 configured to display the text files associated with the product clusters in response to determining that the predicted jump-off point is reached.

The search method, the search server, and the search system provided by the present disclosure generate a text file associated with a product cluster using feature data of a user and a search keyword, and push the text file, since a form of a text file is used for pushing to a user, thus helping the user to stay in a search interface in a more effective manner, and effectively improving the user's click-through rate and transaction rate.

Although the present disclosure provides method operations as described in the examples or flowcharts, more or fewer operations may be included according to routine or non-creative labor. An order of the operations recited in the embodiments is merely one of a plurality of execution orders and does not represent a unique order of execution. In practice, when a device or client product is executed, the operations may be executed according to the method as shown in the embodiment or the figure or in parallel (for example, a parallel processor or a multi-threaded processing environment).

The devices or modules set forth in the above embodiments may be specifically implemented by a computer chip or an entity, or may be implemented by a product having certain functions. For the convenience of description, the above devices are divided into various modules in terms of functions for separate descriptions. The functions of each module may be implemented in one or more software and/or hardware when implementing the present disclosure. Apparently, a module that implements a certain function may also be implemented by a combination of sub-modules or subunits.

The methods, devices, or modules described in the present disclosure may be implemented by a controller that is implemented in a manner of computer readable program codes in any suitable manner. For example, a controller may take, for example, a microprocessor or processor and computer-readable media storing computer readable program code (eg, software or firmware) executable by the (micro) processor, logic gates, switches, application-specific integrated circuits (ASICs), programmable logic controllers, and embedded microcontrollers. Examples of controllers include, but are not limited to, the following microcontrollers: ARC 625D, Atmel AT91SAM, Microchip PIC18F26K20, and Silicon Labs C8051F320. A controller of memory may also be implemented as a part of control logic of the memory. One skilled in the art also knows that, besides implementing the controller in a manner of purely computer-readable program codes, method operations can be logically programmed entirely to allow the controller to implement the same functions in a form of logic gates, switches, application-specific integrated circuits, programmable logic controllers, and embedded microcontrollers. Therefore, this type of controller may be considered as a hardware component, and apparatuses included therein for realizing various functions may also be regarded as structures within the hardware component. Or, even an apparatus for realizing various functions may be regarded as a software module that implements the method, and may also be a structure within a hardware component.

Some modules in the apparatuses described herein may be described in the general context of computer-executable instructions executed by a computer, such as program modules. Generally, program modules include routines, programs, objects, components, data structures, types, etc., that perform particular tasks or implement particular abstract data types. The present disclosure may also be practiced in distributed computing environments. In these distributed computing environments, tasks are performed by remote processing devices that are connected through a communications network. In a distributed computing environment, program modules may be located in both local and remote computer storage media including storage devices.

As can be seen from the description of the above embodiments, one skilled in the art can clearly understand that the present disclosure can be implemented by means of software plus necessary hardware. Based on this understanding, the essence of the technical solutions of the present disclosure or the part contributing to the existing technologies may be embodied in a form of a software product or may be embodied in an implementation of data migration. This computer software product may be stored in a storage media, such as a ROM/RAM, a magnetic disk, an optical disk, etc., and includes instructions to cause a computing device (which may be a personal computer, a mobile terminal, a server, or a network device, etc.) to execute the methods described in various embodiments or certain parts of the embodiments of the present disclosure.

Various embodiments in the present specification are described in a progressive manner, and the same or similar parts among the various embodiments may be referenced to each other. Each embodiment focuses on an aspect that is different from those of other embodiments. All or part of the present disclosure can be used in many general purpose or specialized computer system environments or configurations. Examples are personal computers, server computers, handheld or portable devices, tablet-type devices, mobile communication terminals, multiprocessor systems, microprocessor-based systems, programmable electronic devices, network PCs, minicomputers, mainframe computers, and distributed computing environments including any of the above systems or devices.

Although the present disclosure has been described through embodiments, one of ordinary skill in the art understands that there are many variations and changes to the present disclosure without departing from the spirit of the application. It is intended that the appended claims include such modifications and changes without departing from the spirit of the present disclosure.

The present disclosure can be further understood using the following clauses.

Clause 1: A search method comprising: obtaining feature data of a user and a search keyword; generating text files associated with product clusters based on the feature data of the user and the search keyword; and displaying the text files associated with the product clusters on a search result browsing interface corresponding to the search keyword.

Clause 2: The method according to Clause 1, wherein generating the text files associated with the product clusters based on the feature data of the user and the search keyword comprises: determining a basic feature vector of the user under the search keyword based on the feature data of the user; obtaining a product cluster set, wherein the product cluster set stores a number of product clusters, and each product cluster corresponds to a product cluster feature vector; selecting a preset number of product clusters from the product cluster set based on the basic feature vector of the user, the product cluster feature vector of each product cluster, and historical clicking activity data of the user; and generating text files allocating for the preset number of product clusters.

Clause 3: The method according to Clause 2, wherein the basic feature vector of the user comprises at least one of the following: an age of the user, a gender of the user, and a city of the user.

Clause 4: The method according to Clause 2, wherein selecting the preset number of product clusters from the product cluster set based on the basic feature vector of the user, the product cluster feature vector of each product cluster, and the historical clicking activity data of the user comprises: selecting a plurality of product clusters whose degree of similarity between a respective product cluster feature vector and the basic feature vector of the user exceed a preset threshold from the product cluster set to form a candidate product cluster set; acquiring the historical clicking activity data of the user; and selecting a preset number of product clusters with the highest matching degree from the candidate product cluster set based on the historical clicking activity data of the user.

Clause 5: The method according to Clause 2, wherein generating text files allocating for the preset number of product clusters comprises selecting a text file for each product cluster in the preset number of product clusters from a pre-established collection of text files.

Clause 6: The method according to Clause 5, wherein the pre-established collection of text files is established in the following manner: obtaining text file information of historical text files, wherein the text file information includes at least one of the following: categories, products, brands, times of release, conversion rates for placement, transaction conversion rates, and keywords; and selecting text files to generate the collection of text files based on the text file information of the historical text files.

Clause 7: The method according to Clause 6, wherein selecting the text file for each product cluster in the preset number of product clusters from the pre-established collection of text files comprises: obtaining click-through rate data of the user for the historical text files; sorting each text file in the collection of text files according to respective click-through rates based on click-through rate data of the user for the historical text files; and selecting text files matching product clusters of which respective text files are to be generated and having a high click-through rate as the respective text files of the product clusters of which the respective text files are to be generated.

Clause 8: The method according to Clause 2, wherein generating the text files allocating for the preset number of product clusters comprises: obtaining click-through rate data of the user for historical text files; and generating a text file for each product cluster in the preset number of product clusters based on the click-through rate data, the search keyword, and features of products in the product clusters.

Clause 9: The method according to any one of Clauses 1 to 8, wherein displaying the text files associated with the product clusters on the search result browsing interface corresponding to the search keyword comprises displaying the text files associated with the product clusters at a predicted jump-off point of the search result browsing interface corresponding to the search keyword.

Clause 10: A search server comprising: an acquisition module configured to obtain feature data of a user and a search keyword; a generation module configured to generate text files associated with product clusters based on the feature data of the user and the search keyword; and a display module configured to display the text files associated with the product clusters on a search result browsing interface corresponding to the search keyword.

Clause 11: The search server according to Clause 10, wherein the generation module comprises: a determining unit configured to determine a basic feature vector of the user under the search keyword based on the feature data of the user; an acquisition unit configured to obtain a product cluster set, where the product cluster set stores a plurality of product clusters, and each product cluster corresponds to a product cluster feature vector; a selection unit configured to select a preset number of product clusters from the product cluster set based on the basic feature vector of the user, the product cluster feature vector of each product cluster, and historical clicking activity data of the user; and a generation unit configured to generate text files for the preset number of product clusters.

Clause 12: The search server according to Clause 11, wherein the selection unit comprises: a first selection subunit configured to form a candidate product cluster set consisting of a plurality of product clusters whose degree of similarity between a respective product cluster feature vector and the basic feature vector of the user exceeds a preset threshold from the product cluster set; an acquisition subunit configured to obtain historical clicking activity data of the user; and a second selection subunit is configured to select a preset number of product clusters with a highest matching degree from the candidate product cluster set based on historical clicking activity data of the user.

Clause 13: The search server according to Clause 11, wherein the generation unit is configured to select a text file for each product cluster in the preset number of product clusters from a pre-established collection of text files.

Clause 14: The search server according to Clause 13, further comprising: an establishing module configured to establish the pre-established collection of text files in the following manner: obtaining text file information of historical text files, wherein the text file information includes at least one of the following: categories, products, brands, times of release, conversion rates for placement, transaction conversion rates, and keywords; and selecting text files to generate the collection of text files based on the text file information of the historical text files.

Clause 15: The search server according to Clause 14, wherein the generation unit comprises: a third acquisition subunit configured to obtain click-through rate data of the user for the historical text files; a sorting subunit configured to sort each text file in the collection of text files according to respective click-through rates based on click-through rate data of the user for the historical text files; and a first generation subunit configured to select text files matching product clusters of which respective text files are to be generated and having a high click-through rate as the respective text files of the product clusters of which the respective text files are to be generated.

Clause 16: The search server according to Clause 11, wherein the generation unit comprises: a fourth acquisition subunit configured to obtain click-through rate data of the user for historical text files; and a second generation subunit configured to generate a text file for each product cluster in the preset number of product clusters based on the click-through rate data, the search keyword, and features of products in the product clusters.

Clause 17: The search server according to any one of Clauses 10 to 16, wherein the display module comprises: a prediction unit configured to predict whether a predicted jump-off point of the search result browsing interface corresponding to the search keyword is reached; and a display unit configured to display the text files associated with the product clusters in response to determining that the predicted jump-off point is reached.

Clause 18:A search system comprising the search server according to any one of Clauses 10-17, and a plurality of user clients, wherein the user client is configured to obtain a search keyword inputted by a user, present a text file displayed by the search server, and display a product cluster associated with the text file in response to receiving a click command of the text file.

Clause 19: A search method comprising: obtaining feature data of a user and a search keyword; generating a text file associated with a product cluster based on the feature data of the user and the search keyword; and displaying the text file associated with the product cluster on a user purchase activity result interface corresponding to the search keyword.

Clause 20: A computer-readable storage media having stored a computer program thereon that, when executed by processor(s), implements the operations of the method according to any one of Clauses 1-9.

What is claimed is:

1. A method implemented by one or more computing devices, the method comprising:
obtaining feature data of a user and a search keyword;
generating text files associated with product clusters based on the feature data of the user and the search keyword; and
displaying the text files associated with the product clusters on a search result browsing interface corresponding to the search keyword.

2. The method according to claim 1, wherein generating the text files comprises:
determining a basic feature vector of the user under the search keyword based on the feature data of the user;
obtaining a product cluster set, wherein the product cluster set includes a number of product clusters, and each product cluster corresponds to a product cluster feature vector;
selecting a preset number of product clusters from the product cluster set based on the basic feature vector of the user, the product cluster feature vector of each product cluster, and historical clicking activity data of the user; and
generating text files allocating for the preset number of product clusters.

3. The method according to claim 2, wherein the basic feature vector of the user comprises at least one of the following: an age of the user, a gender of the user, and a city of the user.

4. The method according to claim 2, wherein selecting the preset number of product clusters from the product cluster set comprises:
selecting a plurality of product clusters whose degree of similarity between a respective product cluster feature vector and the basic feature vector of the user exceed a preset threshold from the product cluster set to form a candidate product cluster set;
acquiring the historical clicking activity data of the user; and
selecting a preset number of product clusters with a highest matching degree from the candidate product cluster set based on the historical clicking activity data of the user.

5. The method according to claim 2, wherein generating text files allocating for the preset number of product clusters comprises selecting a text file for each product cluster in the preset number of product clusters from a pre-established collection of text files.

6. The method according to claim 5, wherein the pre-established collection of text files is established by:
obtaining text file information of historical text files, wherein the text file information includes at least one of the following: categories, products, brands, times of release, conversion rates for placement, transaction conversion rates, and keywords; and
selecting text files to generate the collection of text files based on the text file information of the historical text files.

7. The method according to claim 6, wherein selecting the text file for each product cluster in the preset number of product clusters from the pre-established collection of text files comprises:
obtaining click-through rate data of the user for the historical text files;
sorting each text file in the collection of text files according to respective click-through rates based on click-through rate data of the user for the historical text files; and
selecting text files matching product clusters of which respective text files are to be generated and having a high click-through rate as the respective text files of the product clusters of which the respective text files are to be generated.

8. The method according to claim 2, wherein generating the text files allocating for the preset number of product clusters comprises:
obtaining click-through rate data of the user for historical text files; and
generating a text file for each product cluster in the preset number of product clusters based on the click-through rate data, the search keyword, and features of products in the product clusters.

9. The method according to claim 1, wherein displaying the text files associated with the product clusters on the search result browsing interface corresponding to the search keyword comprises displaying the text files associated with the product clusters at a predicted jump-off point of the search result browsing interface corresponding to the search keyword.

10. A server comprising:
one or more processors;
memory;
an acquisition module stored in the memory and executable by the one or more processors to obtain feature data of a user and a search keyword;
a generation module stored in the memory and executable by the one or more processors to generate text files associated with product clusters based on the feature data of the user and the search keyword; and
a display module stored in the memory and executable by the one or more processors to display the text files associated with the product clusters on a search result browsing interface corresponding to the search keyword.

11. The server according to claim 10, wherein the generation module comprises:
a determining unit configured to determine a basic feature vector of the user under the search keyword based on the feature data of the user;
an acquisition unit configured to obtain a product cluster set, where the product cluster set stores a plurality of product clusters, and each product cluster corresponds to a product cluster feature vector;
a selection unit configured to select a preset number of product clusters from the product cluster set based on the basic feature vector of the user, the product cluster feature vector of each product cluster, and historical clicking activity data of the user; and
a generation unit configured to generate text files for the preset number of product clusters.

12. The server according to claim 11, wherein the selection unit comprises:
a first selection subunit configured to form a candidate product cluster set consisting of a plurality of product clusters whose degree of similarity between a respective product cluster feature vector and the basic feature vector of the user exceeds a preset threshold from the product cluster set;
an acquisition subunit configured to obtain historical clicking activity data of the user; and
a second selection subunit is configured to select a preset number of product clusters with a highest matching degree from the candidate product cluster set based on historical clicking activity data of the user.

13. The server according to claim 11, wherein the generation unit is configured to select a text file for each product cluster in the preset number of product clusters from a pre-established collection of text files.

14. The server according to claim 13, further comprising: an establishing module configured to establish the pre-established collection of text files by:
obtaining text file information of historical text files, wherein the text file information includes at least one of the following: categories, products, brands, times of release, conversion rates for placement, transaction conversion rates, and keywords; and
selecting text files to generate the collection of text files based on the text file information of the historical text files.

15. The server according to claim 14, wherein the generation unit comprises:
a third acquisition subunit configured to obtain click-through rate data of the user for the historical text files;
a sorting subunit configured to sort each text file in the collection of text files according to respective click-through rates based on click-through rate data of the user for the historical text files; and
a first generation subunit configured to select text files matching product clusters of which respective text files are to be generated and having a high click-through rate as the respective text files of the product clusters of which the respective text files are to be generated.

16. The server according to claim 11, wherein the generation unit comprises:
a fourth acquisition subunit configured to obtain click-through rate data of the user for historical text files; and
a second generation subunit configured to generate a text file for each product cluster in the preset number of product clusters based on the click-through rate data, the search keyword, and features of products in the product clusters.

17. The server according to claim 10, wherein the display module comprises:
a prediction unit configured to predict whether a predicted jump-off point of the search result browsing interface corresponding to the search keyword is reached; and
a display unit configured to display the text files associated with the product clusters in response to determining that the predicted jump-off point is reached.

18. One or more computer readable media storing executable instructions that, when executed by one or more processors, cause the one or more processors to perform acts comprising:
obtaining feature data of a user and a search keyword;
generating text files associated with product clusters based on the feature data of the user and the search keyword; and
displaying the text files associated with the product clusters on a search result browsing interface corresponding to the search keyword.

19. The one or more computer readable media according to claim 18, wherein generating the text files comprises:
determining a basic feature vector of the user under the search keyword based on the feature data of the user;
obtaining a product cluster set, wherein the product cluster set includes a number of product clusters, and each product cluster corresponds to a product cluster feature vector;
selecting a preset number of product clusters from the product cluster set based on the basic feature vector of the user, the product cluster feature vector of each product cluster, and historical clicking activity data of the user; and
generating text files allocating for the preset number of product clusters.

20. The one or more computer readable media according to claim 19, wherein selecting the preset number of product clusters from the product cluster set comprises:
selecting a plurality of product clusters whose degree of similarity between a respective product cluster feature vector and the basic feature vector of the user exceed a preset threshold from the product cluster set to form a candidate product cluster set;
acquiring the historical clicking activity data of the user; and
selecting a preset number of product clusters with a highest matching degree from the candidate product cluster set based on the historical clicking activity data of the user.
